(19) United States
(12) Patent Application Publication
(10) Pub. No.: US 2016/0319134 A1
(43) Pub. Date: Nov. 3, 2016

(54) FIRE RETARDANT, INSULATION MATERIAL AND SURFACE PROTECTANT

(71) Applicant: CMT INDUSTRIES LIMITED, Invercargill (NZ)

(72) Inventor: Hamish Logan McCallum, Invercargill (NZ)

(21) Appl. No.: 15/103,727

(22) PCT Filed: May 20, 2014
(86) PCT No.: PCT/NZ2014/000090

§ 371 Date: Jun. 10, 2016

(30) Foreign Application Priority Data
Dec. 10, 2013 (NZ) 618541

(51) Int. Cl. C09D 5/18; B09B 3/00; C09K 21/04

(52) U.S. Cl. CPC C09D 5/18; C09K 21/04; B09B 3/00

(57) ABSTRACT

The present invention relates to using aluminium dross, an industrial waste product, to prepare a composition having fire retardant, insulating and surface protecting properties. The composition is prepared by reacting aluminium dross particles with an acid, and subjecting the resultant reaction mixture to a drying process. The composition, and articles prepared from or coated with the composition, have enhanced fire retardant, insulating and surface protecting properties. The invention is useful for preparing building materials for use in the construction industry, and for forming protective coatings.

The present invention relates to a composition prepared from aluminium dross, having fire retardant, insulating and surface protecting properties.

### BACKGROUND OF THE INVENTION

Aluminium smelting and re-melting processes produce a number of industrial waste products. Aluminium dross is a hazardous waste substance that is left over from the smelting or re-melting of aluminium.

Two types of aluminium dross commonly produced are black dross and white dross. White dross comprises the two major components aluminium metal (Al (m)) and aluminium oxide, and can comprise smaller amounts of other components, depending upon the conditions in the furnace, as well as the subsequent dross pan, the metal source and the alloys being processed. These other components include aluminium nitride (AlN), aluminium carbide (Al₄C₃) and cryolite (NA₃AlF₆). Cryolite is often associated with molten metal coming from electrolysis cells, while AlN and Al₄C₃ are associated with thermite reactions occurring in the furnace or dross skim pan.

### Aluminium Dross Recycling

Aluminium dross has a number of applications in the ceramic industry, steel industry and the cement industry; for example, in the steel industry aluminium dross can be finely ground and used as a flux. Various processes for recovering additional Al (m) from aluminium dross have been described; however, most aluminium dross applications require aluminium dross having an appreciable quantity of Al (m).

Alternatively, aluminium dross is rendered neutral or inert and then disposed as land fill.

U.S. Pat. No. 4,475,940 teaches a process of adding phosphoric acid to aluminium dross, to provide a plastic composition which results in a wet meal. The meal is agitated until it forms a granulated product, having particle sizes of 1.6 mm-2.4 mm for use as a fertilizer.

NZ 238178 describes optionally pre-treating aluminium dross to remove particle sizes above 0.8 mm, washing the dross in dilute acid for a period of about 1 hour in a (rotary) screen washing apparatus and/or cyclone washing, and harvesting the particles from the liquor produced. The particles are proposed as a medium for sand blasting. Other uses mentioned for the particles include in granulated superphosphate fertilizers, and as additives/fillers in bricks, including fire bricks, paving or roading materials, agricultural or domestic drainage tiles and paints.

U.S. Pat. No. 4,320,098 describes slurrying aluminium dross tailings (aluminium dross milled and screened to remove Al particles), heating and agitating the slurry, and then reacting the slurry with 30-99 wt % sulfuric acid. The pressure and temperature are then increased while maintaining the reaction in liquid phase; the reaction produces aluminium sulfate.

US 20050016395 describes calcination of aluminium residue ash and proposes the product as a fire proof material. Aluminium residue ash is described as the surplus material left over after treating aluminum slag by separating and recycling the aluminum metal from the aluminum slag.

### Fire Retardation

In the construction industry, fire retardants are added to building construction materials to delay their failure in the event of a fire and allow safe escape of the occupants of the building. Fire retardants can be incorporated into composite materials, or applied as a coating to the surfaces of building materials.

### OBJECT OF THE INVENTION

It is an object of the present invention to obtain a useful product from left over aluminium dross, or at least to provide a useful alternative to disposing left over dross as land fill.

It is another independent object of the invention to provide a product which has fire retardant and/or insulating and/or surface protecting properties, or at least to provide the public with a useful choice.

### SUMMARY OF THE INVENTION

In a first broad aspect, the present invention provides a method of preparing a composition having fire retardant, insulating and/or surface protecting properties, the method comprising reacting aluminium dross particles with an acid, and subjecting the resultant reaction mixture to a drying process.

In another aspect, the present invention provides a composition having fire retardant, insulating and/or surface protecting properties prepared by reacting aluminium dross particles with an acid, and subjecting the resultant reaction mixture to a drying process.

In another aspect, the present invention provides an article comprising a composition, said composition having fire retardant, insulating and/or surface protecting properties prepared by reacting aluminium dross particles with an acid, and subjecting the resultant reaction mixture to a drying process.

The article may be coated with the composition or may comprise the composition which has been cast into a desired shape.

In another aspect, the present invention provides a method of providing fire resistance to an article, the method comprising applying to the article a fire retardant composition prepared by reacting aluminium dross particles with an acid, and subjecting the resultant reaction mixture to a drying process.

The drying process may be a passive process, involve an active drying process or be a combination of passive and active drying.

In a preferred embodiment, the article is a building material.

In another aspect, the present invention provides a use of a reaction product of aluminium dross particles and an acid to prepare a composition having fire retardant, insulating and/or surface protecting properties.

Preferably, the aluminium dross particles have a size of 2 mm or less.

Preferably, the liquid content of the reaction mixture is 50-1000 mL per kg dross, more particularly preferably 100-350 mL per kg dross.

The aluminium dross particles and the acid are preferably reacted by mixing for 10-15 min. The reaction may reach a temperature in the range of 50-90 degrees C., for example a temperature in the range of 65-75 degrees C.

Preferably the acid is a mineral acid, such as phosphoric acid. Preferably, the acid has a concentration of at least 50 w/w %.

The reaction mixture may optionally be applied to an article before being subjected to the drying process, for example by spraying, trowelling, moulding, or forming. Preferably, the reaction mixture is dried passively. The drying process may take place over at least 12 hours, for example over at least 24 hours.

### BRIEF DESCRIPTION OF THE FIGURES

FIG. 1 shows successive views of a flame test of a gypsum plasterboard coated with the composition of the invention described in Example 3 (left) against a control gypsum plasterboard (right).

FIG. 2 shows a propane burner flame test of a medium density fibre board (MDF) coated with the composition of the invention described in Example 4 (left), against a control MDF (right).

FIG. 3 shows a flame test of a wool polyester ceiling batt infused with a composition of the invention as described in Example 5 (left), against a control wool polyester ceiling batt (right).

FIG. 4 shows a flame test of a polystyrene block coated with a composition of the invention described in Example 6 (left), against a control polystyrene block (right).

FIG. 5 shows the setup for the flame test of a steel plate to which is adhered a composition of the invention, including the thermal couple used to record heat transfer, described in Example 7.

FIG. 6 shows results for the flame test of a steel plate to which is adhered a composition of the invention, described in Example 7.

### DETAILED DESCRIPTION OF THE INVENTION

White dross is created by the skimming of furnaces during the aluminium smelting process. White dross can include oxide compounds not directly formed in the furnace, but which are introduced during the treatment process. White dross typically contains no salt flux.

In an exemplary hot dross process, the dross is skimmed into dross buckets which are then subjected to a rotation process. Al (m) is then collected from the dross buckets and spilled into a catchment sow. The remaining dross, having a lower Al (m) content, is then set aside to cool.

Once cooled, this dross is easily broken down using a cold dross process. This can be done by a variety of mechanical processes. At this stage, remaining Al (m) which is negatively charged can be separated from the aluminium dross using an eddy current separator. The processed dross, further depleted in Al (m), is then collected and can have particle sizes of up to 10-15 mm. Dross which has been processed using an eddy current separator needs to be crushed and generally does not need to be processed in the eddy current separator a second time; however, in some cases this may be required.

Because the mechanical process is inherently dusty, dross dust can also be collected using bag house filtration, which collects airborne dross particles.

Black dross is treated mechanically in the same manner as white dross; however, when the dross comes from the furnace it is allowed to cool, and at the re-melt stage, which generally takes place in a rotation furnace, the dross is dosed with salt. This recovery is called a salt cake process, and renders the dross very toxic. However, in some processes, such as that used by Weston Aluminium in Australia, the salt cake is then washed. The salt cake may retain salt even after the washing process.

The present invention involves the reaction of aluminium dross particles with an acid, to produce a reaction mixture which can be used to form fire-resistant and insulating products.

It is advantageous to use white dross in the invention. The use of black dross does not create the same intense exothermic reaction; however, the reaction can be achieved using black dross, by adding substantially more acid. The intensity of the reaction may have an effect on the porosity and structural integrity of the dried composition.

The aluminium dross particles useful in the process of the invention can have particle sizes ranging from upwards of 10 mm to less than 1 mm. It has been found that the use of aluminium dross having a particle size of 10 mm or less, particularly 2 mm or less is particularly useful in the invention. The aluminium dross particles can be sized by any means known in the art. For example, the dross can be sieved by air wash, sieved using a kitchen sieve or other sieve of appropriate mesh to achieve the desired particle size; alternatively a vibrating table or trommel can be used.

### Definitions

As used herein, the term “aluminium dross” refers to a by-product of an aluminium smelting or re-melting process.

As used herein, the term “reaction mixture” refers to the mixture of the aluminium dross and the acid in its plastic or pre-dried state.

As used herein, the term “dried composition” refers to the reaction product of the aluminium dross and the acid in its dried state.

The inventor has found that by reacting aluminium dross particles with an acid, a composition with excellent fire retardant, insulating and surface protecting properties can be produced.

### Acid

Preferably, the acid is a mineral acid. Phosphoric acid is preferred, but it will be appreciated that other acids such as nitric acid, hydrochloric acid and sulphuric acid may be used. The acid employed may advantageously be at a concentration of 50% w/w or greater, for example, 80% w/w or greater or 90% w/w or greater.

### Reaction Mixture

Typically, the reaction mixture may be prepared by mixing the aluminium dross particles with acid. Optionally, the aluminium dross particles can first be sized before mixing with the acid. Optionally, the aluminium dross particles can first be dampened with water before adding the acid. Advantageously, the liquid content of the reaction mixture is 50-550 mL per kg dross, such as 100-350 mL per kg dross.

Upon mixing, a spontaneous exothermic reaction takes place. The reaction may be vigorous, and may cause a rise in temperature to 50-90° C. This reaction may proceed for a number of minutes before slowing.

Optionally, prior to the drying process, the reaction mixture can be applied as a coating to a surface for which enhanced fire resistance or insulation is desired. Alternatively, the reaction mixture may be allowed to set, either in the reaction vessel or in a mould of a desired shape.

It will be appreciated that the reaction mixture can be dried either passively, by allowing evaporation of water from the reaction mixture, or actively, for example by passing air, including warm air, over the reaction mixture, for example by using a blow drier, or a soft flame to evaporate moisture held within the reaction mixture. While drying, the reaction mixture is not agitated or disturbed. Drying of the reaction mixture may take place in a number of hours, for example 12 hours, 24 hours or 48 hours.

### Application of Reaction Mixture as a Coating

When it is desired to apply the reaction mixture as a coating to a surface, the reaction mixture can be applied using a number of means, including heavy duty spray apparatus, trowelling, moulding, and forming. While the reaction mixture “self-primes”, meaning that no surface preparation of the substrate is necessary, it will be appreciated that the surface to which the reaction mixture is applied can be pre-treated by scarifying, sanding or sand blasting. Additionally, the surface can be prepared by applying binders or adhesives to the surface, prior to application of the reaction mixture. For example, a rubberised binder can be used for flexibility and to improve adhesion of the reaction mixture to the surface.

### Additional Coating

Optionally, a further coating can be applied to the dried composition, to seal the product and render it weather proof, thereby significantly improving the surface tension.

In an embodiment, the further coating can provide additional fire protection. For example, the further coating can be an intumescent paint. For example, the further coating can be a fire-resistant acrylic paint, such as CAP508 produced by CAP Coatings Australia.

In an embodiment, the further coating can be an acrylic water-based paint, such as that produced by Vipond's Paints Australia. Optionally, two coatings of acrylic water-based paint can be applied. A coating of acrylic water-based paint is a cost-effective and high quality means of sealing the dried composition. Acrylic coatings are preferred as they have fewer detrimental environmental effects than other coating options. Additionally, they bond readily to the dried composition without the need for surface preparation, and provide structural integrity, surface flexibility and water proofing.

Optionally, particularly in cases where the substrate is a metal, a primer such as an acrylic metal primer can be added to the substrate prior to applying the reaction mixture. The primer may help to avoid any shock rust reaction that may occur as a result of applying a water-based system to metal.

### Uses and Products

The reaction mixture can be adapted to a number of useful products.

In an embodiment, the composition can provide a high fire rating to industrial steel in various applications including, but not limited to structural steel, oil and gas vessels. For example, the composition can provide pipe protection, tank protection, protection of electrical panels, and protection of engine rooms.

Additionally, the composition can be used as a rust-proof or sealant coating. Surface protection of rust-compromised surfaces can be achieved by application of the composition to a rusted surface such as a corrugated iron roof. The composition seals the rust, preventing further oxidation and filling in rust holes. The composition can also act to seal a surface against degradation. For example, application of the composition to an asbestos-containing substrate can prevent degradation of the surface and migration of asbestos particles. The composition also acts to insulate the surface.

It is also possible to decant a finer liquid from the reaction mixture to produce a malp (heavy paint). The malp may be painted onto various surfaces, for example by brush or roller. The malp is also self-priming with strong adhesive qualities, and does not allow any flame spread even when coated by a waterproof coating.

It will be appreciated that when coating a material to achieve an improved fire rating, the resultant fire rating will depend on the coating thickness. Consequently, the coating thickness applied can be adjusted to achieve the desired fire rating. For example, the coating thickness for a malp can be in the range of 1-10 mm, such as 3 mm. As is known in the art, the coating thickness for a paint can be in the range of micron thicknesses. As the coatings, malps and paints are self-priming, there is no need to prepare the surface before application.

The reaction mixture can also be moulded into a desired shape and dried, to produce a fire-resistant block. The blocks so produced reflect heat, and are therefore also useful as insulators; for example as fire bricks in furnaces and furnace linings, or in providing a cool walking surface in areas which receive high solar radiation.

While the process of the invention is capable of producing solid blocks of dried composition as will be described in detail below, it is envisaged that lime and cement can also be incorporated into the dried composition for use in a range of castables and fire bricks, such that would in used in furnaces and furnace linings

A block of dried composition can be processed into a powder or granulate form, and added as a suspended solid into paints or other protective coatings, or incorporated into existing building materials such as plasterboard, so as to enhance the thermal and fire ratings of the paints, coatings or building materials.

It will also be shown that porous materials such as cloth and insulation wool can be infused with the reaction mixture, which can then be allowed to dry, in order to provide enhanced fire resistance to the porous materials.

The invention will now be described by reference to the following non-limiting examples.

### EXAMPLES

### Example 1—Preparation of Reaction Mixture

2 kg of white aluminium dross having an average particle size of 4 mm was obtained from Weston Aluminium Australia. The dross was sized by passing through a kitchen sieve and was then placed in a large mixing bowl, and dampened with a small amount of water. Evolution of ammonia gas was observed. It is also expected that other gases would be given off by the exposure of the dross to water.

250 grams of phosphoric acid, food grade 80% w/w was then immediately added, and the components were mixed with a trowel to produce a reaction mixture. Within the first 30 seconds of the acid being added, the exothermic reaction between the aluminium dross and the acid produced an increase in temperature and hydrogen sulfide gas. The reaction mixture was then mixed thoroughly so as the acid had come in contact with all the materials within the mixing bowl. Bubbling of the material started within 1 minute and steam could be seen arising from the mixing bowl.

### Example 2—Preparation of Malp

Black aluminium dross was obtained from Australia (Weston Aluminium). The particle size was decreased by passing through a flour sieve. 1 kg of aluminium dross was damped using 130 mL water. 120 mL of 80% food grade phosphoric acid was then added and stirred until it became liquid. An exothermic reaction was virtually immediate. Stirring was continued to ensure the acid came in to contact with all of the dross. A pungent smell of hydrogen sulfide was recognised as being released from the exothermic reaction.

A significant rise in temperature of the composition started to occur after three minutes. Stirring was continued for a further three to four minutes, before an additional 250 mL of water were added, achieving a consistency of thick paint (malp).

### Example 3—Gypsum Plasterboard

The malp prepared in Example 2 was applied to gypsum plasterboard (standard 5 mm Gib® Board) using a paint brush. No surface preparation was used on the plasterboard, but the malp bonded well. Once placed on the plasterboard the exothermic reaction slowed dramatically. A further coat of the composition was applied to bring it up to an approximately 0.75 mm thick coating. This was left to dry overnight.

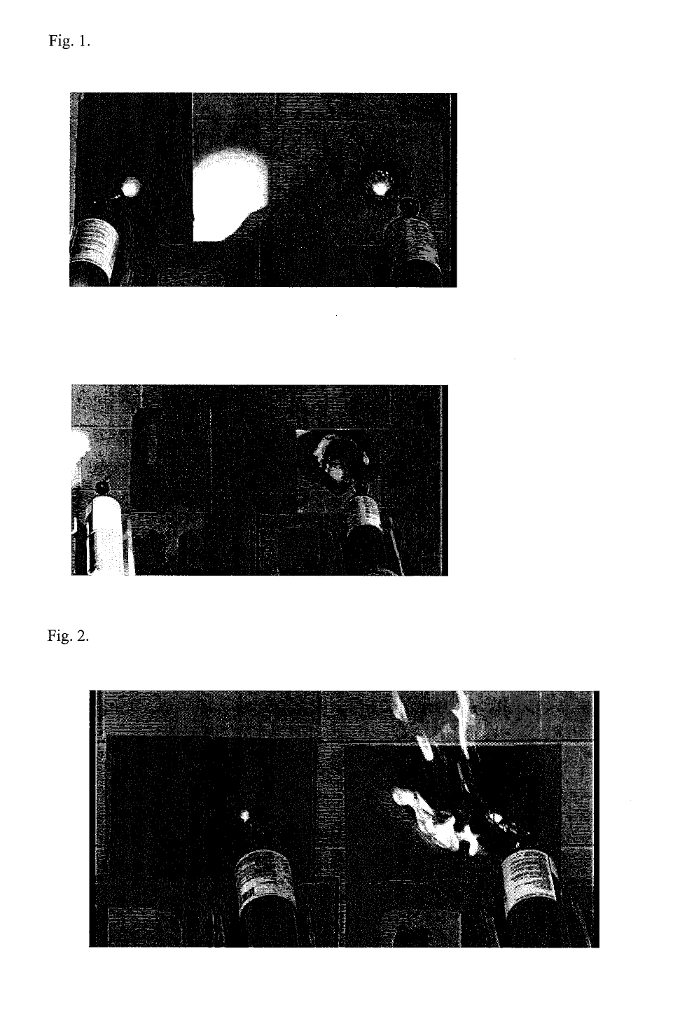

The following morning a flame spread and destruction test was carried out, using a propane gas burner. This setup is shown in FIG. 1. The propane torch was focussed on the board at approximate 20 mm distance for four to five minutes. An oxyacetylene torch was then focussed on the composition to increase the temperature for a further three minutes. A control sample of bare plasterboard (control sample) was subjected to the same process.

### Results

No ignition of the dried composition or the plasterboard underneath was observed. Some discolouration or blistering appeared to occur to the dried composition with extreme heat, estimated at above 1000° C. However, the dried composition remained in place.

The bare plasterboard (control sample) failed within 60 seconds with significant flame spread and was subsequently destroyed by flame.

Ten minutes after commencing the flame test, the area of plasterboard directly behind where the flame was concentrated was warm to touch. There was no further effect on the plasterboard, and the dried composition stayed bonded to the plasterboard throughout the test.

A coating of the composition of less than 1 mm thickness therefore resulted in protection of the plasterboard, where no flame spread was observed and no penetration to the plasterboard or failing of the dried composition was observed. Throughout the testing the back surface of the plasterboard remained warm to the touch.

### Example 4—MDF

The reaction mixture prepared as described in Example 1 was applied as a 4 mm coating to medium density fibreboard (MDF), without prior preparation of the MDF. The coating was allowed to dry for 12 hours. FIG. 2 shows the flame test which resulted in no fire spread.

### Example 5—Wool Polyester Ceiling Batt

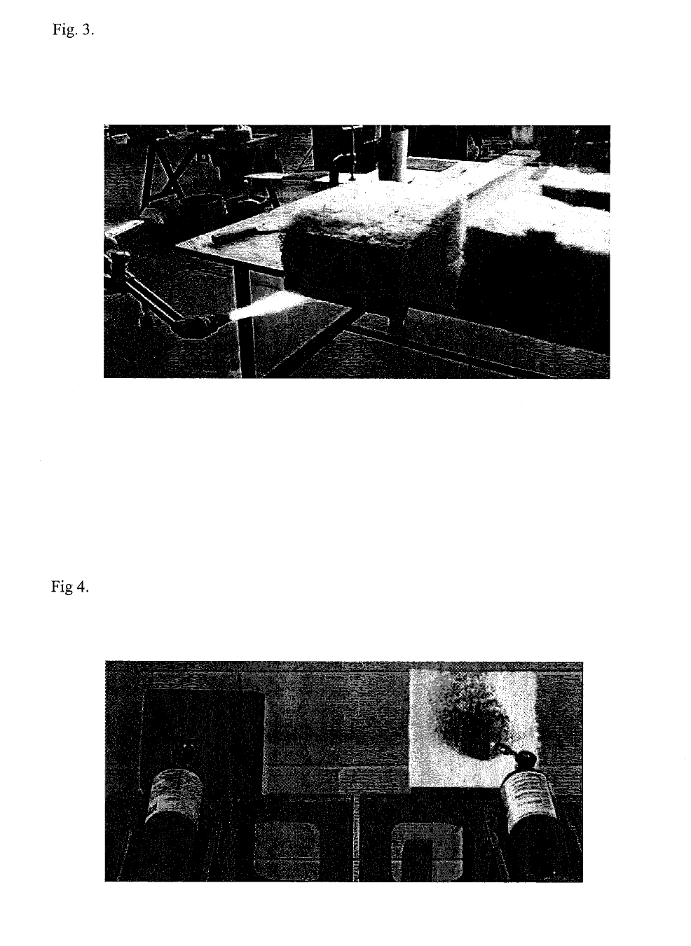

The reaction mixture was prepared as described in Example 1. Once the exothermic reaction was underway, 250 mL water was added, slowing but not stopping the exothermic reaction. The end of the wool batt was dipped repeatedly into the reaction mixture to produce a coating. The coating was given 12 hours to dry, and a flame test was carried out as shown in FIG. 3. The control sample wool batt smoked and charred, while the infused wool batt had enhanced resistance to the burner.

It is envisaged that if the material particle size was significantly smaller, the material could simply be sprayed onto the surface and form a protective coating; alternatively, using a smaller particle size may allow improved impregnation of fibres.

Example 6—Polystyrene Block

The reaction mixture was prepared as described in Example 1 and applied by trowelling to a 60 mm polystyrene board in a 3 mm thick coating. The coating was given 12 hours to dry, and a flame test was carried out as shown in FIG. 4. The control sample of polystyrene not protected by the coating of the invention quickly melted under the flame, but the polystyrene board protected by the coating of the invention remained intact.

### Example 7—Cementitious Block with Steel Backing

The reaction mixture prepared as described in Example 1, and was poured into a mould of predetermined size constructed of polycarbonate plastic. The mould had a thickness of 28 mm; however, it will be appreciated that a mould of any desired size or shape can be formed for use in this aspect of the invention, including moulds having a thickness of up to 300 mm or greater, depending on the desired fire rating. The reaction mixture flowed reasonably evenly and was smoothed out using a hand trowel to give an even thickness in the mould.

The reaction mixture continued to react in the mould for several minutes, producing steam as well as the continued release of hydrogen sulfide. Once the reaction could be visibly seen to slow within the mould, further hand trowelling was required to give an even thickness. The exposed surface was then roughened with the trowel to provide a bonding surface. Within ten minutes, the reaction mixture was partially dried.

The dried composition was left in the mould overnight in a room temperature of 24° C., and was then de-moulded to form a block, and left to dry for a further 24 hours. The dried composition was similar to a ceramic; when tapped a crisp ceramic sound could be heard. Two top coats of a urethane acrylic water-based paint (Vipond's Paints Australia) were then directly applied to the dried composition, which required no undercoat or surface preparation. The painted surface was then allowed to dry.

Observation of the dried composition showed the material structure was similar to a pre-formed cement block, having small and consistent voids throughout its surface. Dissection of the block showed that these voids continue throughout the whole of the dried composition.

In a bonding test which demonstrated the ready bonding between the acrylic paint and the reaction mixture, a further fine coating of reaction mixture was coated directly over one third of the surface of the block, having a thickness of less than 1 mm. This fine coating was produced from white dross obtained from Weston Aluminium Australia that had passed through a kitchen sieve, using the same mixing process with water and phosphoric acid as described above. The fine coating of reaction mixture was simply brushed over the painted surface of the block, and the whole allowed to dry overnight.

A coating of reaction mixture was applied to a steel plate and allowed to dry for 12 hours. A 4 mm coating was then added to the bonding surface of the block, and the pre-coated steel plate was then placed on top, with a small weight to hold it in position. The whole was then allowed to dry and produce a secure bonding.

### Results

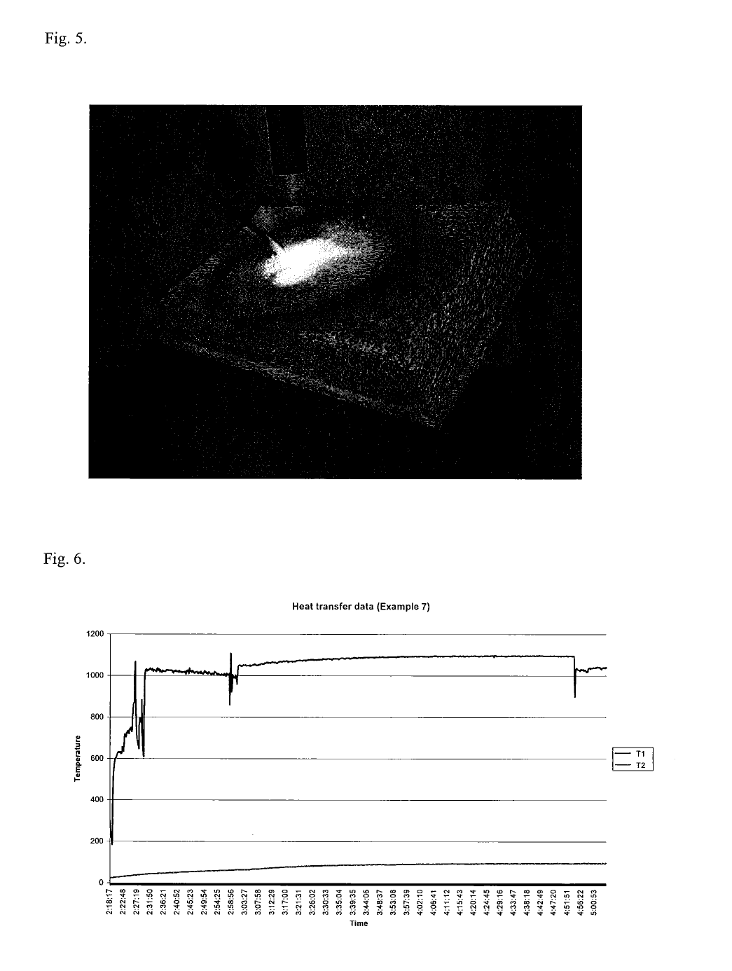

A thermal coupling was place on the front surface of the block and another was placed directly behind the spot where the flame was to meet the front surface. The thermal couples T1 (front couple) and T2 (back couple) were positioned in such a manner that they were consistently under pressure against the surfaces from which the readings were taken (FIG. 5). Thus, the distance between the two thermal couples was the thickness of the block and steel plate. Propane torches were placed within 50 mm of the front surface and directly where the front thermal couple was positioned. The heat transmission through the block was recorded and results are shown in FIG. 6. Data spikes at about 2.30 pm, 3 pm and 4.50 pm indicate replacement or repositioning of the heat source.

The flame test showed that there was a very slow transfer of heat, despite the heat on the front surface reaching over 1000° C. The front surface glowed red; no visible degradation of the material of the surface structurally was observed, despite what would be termed as a blast heat being applied. The maximum temperature recorded on the front surface was 1107° C., while the maximum temperature recorded on the back surface was 98° C. (FIG. 6).

Although the evolution of gases is expected during this process, no gases were observed to be given off.

Although the invention has been described with reference to specific embodiments and examples, it will be appreciated by those skilled in the art that the invention may be embodied in many other forms.

1-17. (canceled)

18. A composition having fire retardant properties prepared by reacting aluminium dross particles with an acid, and subjecting the resultant reaction mixture to a drying process.

19. The composition according to claim 18, wherein the drying process is a passive process, an active drying process or a combination of passive and active drying processes.

20. The composition according to claim 18, wherein the aluminium dross particles have a size of 2 mm or less.

21. The composition according to claim 18, wherein the liquid content of the reaction mixture is 50-1000 mL per kg dross.

22. The composition according to claim 18, wherein the liquid content of the reaction mixture is 100-350 mL per kg dross.

23. The composition according to claim 18, wherein the aluminium dross particles and the acid are reacted by mixing for 10-15 min.

24. The composition according to claim 18, wherein the reaction reaches a temperature in the range of 50-90 degrees C.

25. The composition according to claim 18, wherein the reaction reaches a temperature in the range of 65-75 degrees C.

26. The composition according to claim 18, wherein the acid is a mineral acid.

27. The composition according to claim 18, wherein the acid is phosphoric acid.

28-34. (canceled)

35. An article comprising a composition, said composition having fire retardant properties prepared by reacting aluminium dross particles with an acid, and subjecting the resultant reaction mixture to a drying process.

36. The article according to claim 35, wherein the drying process is a passive process, an active drying process or a combination of passive and active drying processes.

37. The article according to claim 35, wherein the article is coated with the composition.

38. The article according to claim 37, wherein the reaction mixture is applied by spraying, trowelling, moulding, or forming.

39. The article according to claim 35, wherein the article comprises the composition which has been cast into a desired shape.

40. The article according to claim 35, wherein the article is a building material.

41. The article according to claim 35, wherein the aluminium dross particles have a size of 2 mm or less.

42. The article according to claim 35, wherein the liquid content of the reaction mixture is 50-1000 mL per kg dross.

43. The article according to claim 35, wherein the liquid content of the reaction mixture is 100-350 mL per kg dross.

44. The article according to claim 35, wherein the aluminium dross particles and the acid are reacted by mixing for 10-15 min.

45-82. (canceled)
